(19) United States
(12) Patent Application Publication
(10) Pub. No.: US 2013/0290140 A1
(43) Pub. Date: Oct. 31, 2013

(54) Method and Apparatus for Dynamic Visual Content Delivery

(71) Applicants: Scott Frankel, Los Angeles, CA (US); Greg Lam, Los Angeles, CA (US)

(72) Inventors: Scott Frankel, Los Angeles, CA (US); Greg Lam, Los Angeles, CA (US)

(21) Appl. No.: 13/837,281

(22) Filed: Mar. 15, 2013

Related U.S. Application Data
(60) Provisional application No. 61/638,116, filed on Apr. 25, 2012.

(51) Int. Cl. G06Q 30/06

(52) U.S. Cl. CPC G06Q 30/0623
USPC 705/26.61

(57) ABSTRACT

A system includes a processor configured to receive consumer identifying information provided to an in-store display. The processor is also configured to receive a reference to online content. The processor is further configured to retrieve information related to the online content, including one or more items for sale. The processor is additionally configured to determine if at one or more of the items for sale are available in store and provide the user with information about the items, for any of one or more items for sale available in store

### CROSS REFERENCE TO RELATED APPLICATIONS

This Application claims the benefit of U.S. Provisional Application No. 61/638,116, filed Apr. 25, 2012, the disclosure of which is incorporated in its entirety by reference herein.

### TECHNICAL FIELD

The illustrative embodiments generally relate to a method and apparatus for dynamic content delivery.

### BACKGROUND

Advertisers and retailers are always looking for new ways to deliver relevant content to consumers. Digital billboards, dynamic online advertising, static images and a myriad of other choices comprise the current advertising industry.

While digital billboards, for example, can be dynamically changed as desired, the tend to loop to show a particular set of advertisements deemed most suitable for the audience that may view the billboard. Such displays on the highway will usually show advertisements corresponding to renters of the displays, while such displays in a mall, for example, will typically show advertisements about stores in the mall.

As online content creators are presented with more ways to capitalize on consumer-generated revenues, the ability to connect their online content to sources of e-commerce, via referral based marketing channels, is just the beginning of harnessing the power of their readers. By enabling their readers to purchase in the digital space, content creators are indirectly unlocking an additional profit center to capitalize their persuasiveness into the physical world. By aggregating the recommended, advertised, or featured product purchase opportunities by digital content producers into an database, these articles, posts or advertisements can be re-delivered in new, relevant ways, to help drive physical in-store conversions as well.

### SUMMARY

In a first illustrative embodiment, a system includes a processor configured to receive consumer identifying information provided to an in-store display. The processor is also configured to receive a reference to online content. The processor is further configured to retrieve information related to the online content, including one or more items for sale. The processor is additionally configured to determine if at one or more of the items for sale are available in store and provide the user with information about the items, for any of one or more items for sale available in store.

In a second illustrative embodiment, a computer-implemented method includes receiving consumer identifying information provided to an in-store display. The method also includes receiving a reference to online content. The method further includes retrieving information related to the online content, including one or more items for sale. The method additionally includes determining if at one or more of the items for sale are available in store. Also, the method includes providing the user with information about the items, for any of one or more items for sale available in store.

In a third illustrative embodiment, a non-transitory computer readable storage medium, stores instructions that, when executed by a processor, cause the processor to perform a method including receiving consumer identifying information provided to an in-store display. The method also includes receiving a reference to online content. The method further includes retrieving information related to the online content, including one or more items for sale. The method additionally includes determining if at one or more of the items for sale are available in store. Also, the method includes providing the user with information about the items, for any of one or more items for sale available in store.

### BRIEF DESCRIPTION OF THE DRAWINGS

FIG. 1 shows an illustrative content delivery system;

FIG. 2 shows an illustrative example of an advertising-to-retail display model;

FIG. 3 shows an exemplary process for advertisement logging;

FIG. 4 shows an exemplary listing for populating a registry;

FIG. 5 shows an exemplary process for accessing an in-store, interactive display;

FIG. 6 shows an illustrative example of a process for providing a user with a “cart” containing selections of items seen in various online publication;

FIG. 7 shows an illustrative example of a process for in-store cart item searching and recall;

FIG. 8 shows an illustrative example of a process for providing data-feedback and/or a revenue source to online content creators;

FIG. 9 shows an illustrative example of a process for determining which advertisements to be displayed on, for example, a digital display or billboard; and

FIG. 10 shows an illustrative example of a process for providing one or more dynamically adjustable advertisements to consumers.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

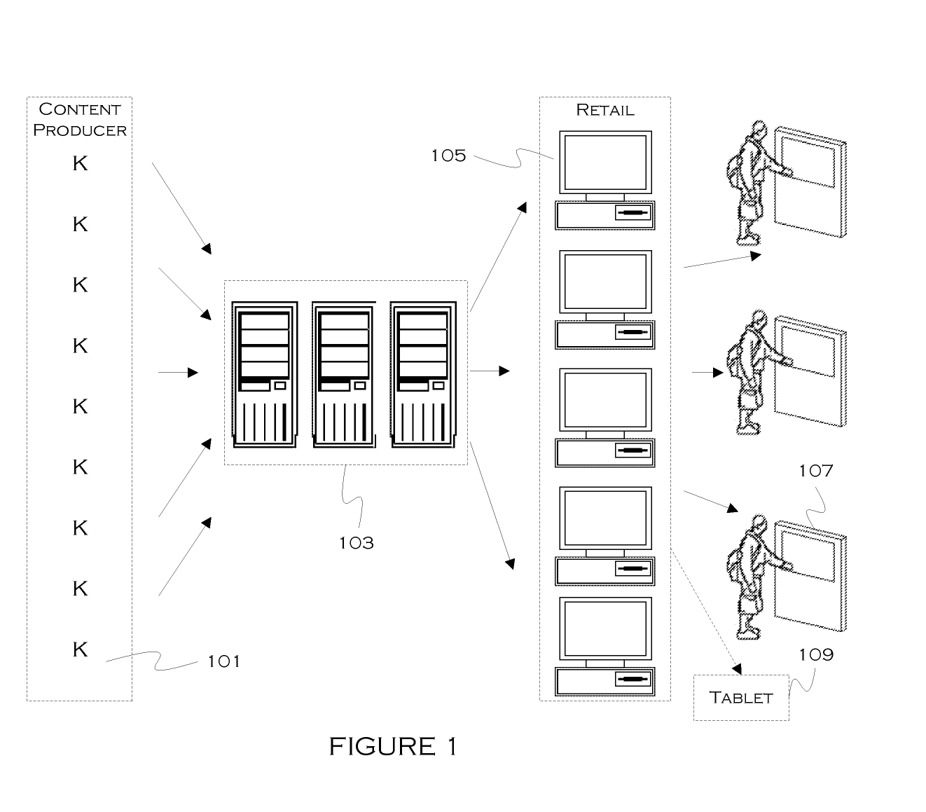

In a first illustrative embodiment, shown in FIG. 1, content producers are capable of creating dynamically linked advertisements to content in their publication. Such a process is described in co-pending and co-owned application Ser. No. 12/535,767 filed on Aug. 5, 2009, the contents of which are incorporated herein by reference.

These advertisements, in this exemplary scenario, are typically items available for purchase online through retail stores and at retail shopping brick and mortar locations. Each advertisement, when created, can provide a consumer with an option to purchase a good from one or more retailers, and may include price info, local or general purchase availability (for in-store purchase), and any other relevant information.

As each advertisement is created, advertisement databases located, for example, at a remote storage location 103, can be updated with a number of factors relating to the advertisement. In one exemplary non-limiting scenario, photographs associated with an online article are “tagged” for advertisement. Various articles displayed in the photographs are associated with various retail providers, such that a reader of the article can also elect to purchase the articles or find out more information about purchase of the articles.

In addition to being served out to online consumers 105, these advertisements can also be data-warehoused for provision to digital displays 107 located in retail stores. These displays, as will be described in greater detail herein, can provide access to a variety of online sources, the products from which can be cross-referenced with retail availability, various retailers, and other similar items of interest.

When a consumer arrives at a retail store that may sell a product the consumer has previously discovered online, the consumer can utilize the retail display to pull up a copy of the article, advertisement, or other display on the in-store display. Based on availability, for example, the store display may then direct the consumer to a section of the store where the product is available. If the product is not available, the store display may offer other local branches selling the product where the product is in-stock, an option to buy the product directly from an online store, or information about similar products that are in-stock at the local store.

In another illustrative example, an in-store network can provide access for portable displays such as tablet computers 109, smart phones, etc. Consumers can then browse known items, previously saved shopping carts, etc., for in-store availability and/or direct purchase. Consumers can also view similar items on personal displays, for suggestions for alternatives to out-of-stock items or items similar to in-stock items desired for purchase.

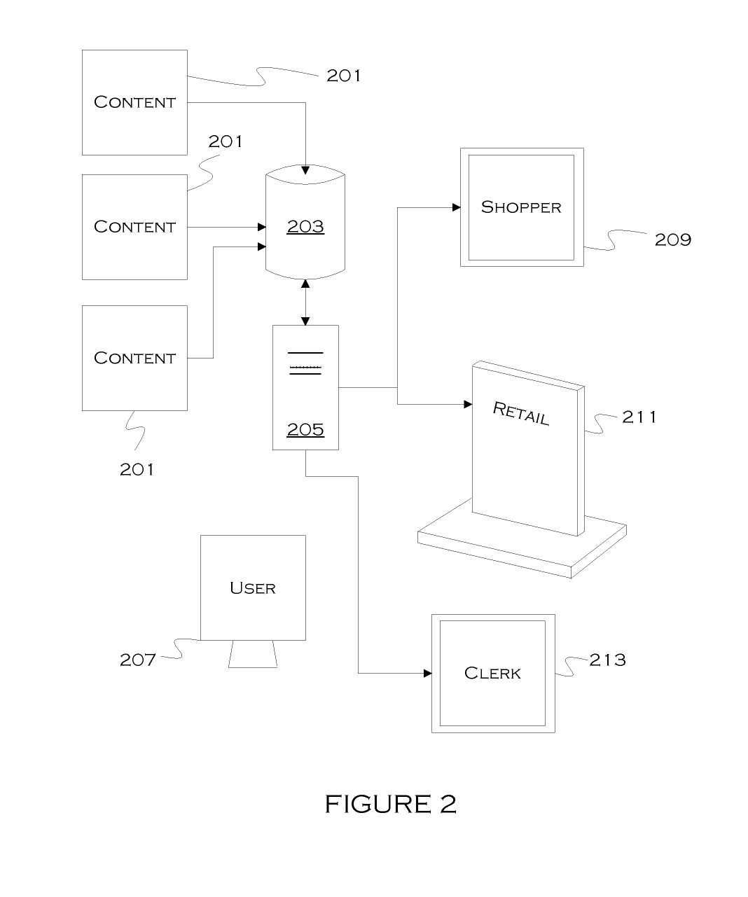

FIG. 2 shows an illustrative example of a second non-limiting advertising-to-retail display model. Similar to the above, content producers create organic sales opportunities within their content, on their individual websites, relating to retail goods associated with articles displayed in, for example, pictures included with a column 201. This advertising information may be saved in a database 203, for access by consumers and local retailers who wish to re-display the indirectly advertised products on-site. One or more servers 205 may access the database to serve the advertisement information out within brick and mortar stores.

In this example, the servers are capable of serving out data to, for example, online shoppers/readers of articles 209, in-store retail displays 211, consumers in a store with a tablet, smart phone or other graphic display 207, store clerks provided with a display 213, etc.

In at least one non-limiting example, the advertisements are provided to an in-store clerk on a tablet computer. The customer can then approach the clerk and describe and work with the clerk to discover a product previously seen online as available at the particular retailer at which the clerk is employed. Utilizing the tablet, the clerk can access the database, sorted by content provider, for example, and pull up the particular article, pictures and advertisement provided to the consumer. The clerk can then provide the consumer with assistance in finding the item sought within the store. This may also provide an opportunity for the clerk to provide alternatives to a product, in the event the consumer may desire additional options. Additionally, an algorithm may provide similar items, based on the selected products characteristics, to additionally share with the customer.

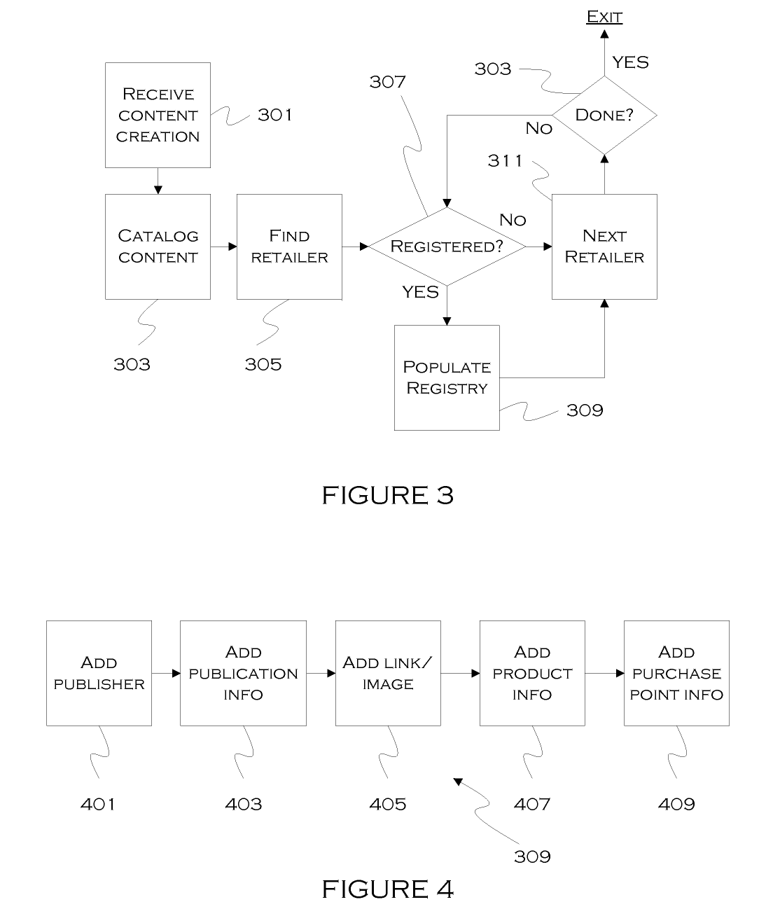

FIG. 3 shows an exemplary process for advertisement logging. In this non-limiting example, a intermediary receives indicia of a new content-to-commerce connection having been created 301. This creation can be, for example, through an online content provider who has linked one or more products to one or more retailers also participating in offering items for sale through the intermediary.

The content can be cataloged in the database for later access by online consumers wishing to purchase or view the item through the link created by the content provider 303. This can provide online, direct access for purchasing the item. In addition to cataloging the item for online purchase, however, the item may also be identifiable by one or more characteristics associated with the item.

For example, without limitation, the item may have a SKU or UPC associated therewith that identifies the item. In another example, a manufacturer, item name, or selected retailer may be used to further or uniquely identify a particular item. Since the online intermediary may contain a list of one or more retailers who sells a particular item, the process may utilize item identifying information to identify at least one retailer who sells the item in question 305.

In some instances, for example, if a SKU, UPC or manufacturer is used to identify an item, the intermediary may identify all retailers associated with an item. In other instances, for example, if a particular retailer has been associated with an item, the intermediary may only link that particular retailer with the item. Of course, if the content provider or intermediary provider so desires, all retailers providing an item may be associated with the item, regardless of content provider created linkages identifying a particular retailer.

For example, without limitation, content provider A may have items 1 and 2 for sale. Item 1 may be identified through SKU/UPC 111-111 and the content provider may wish to have the intermediary link all possible retailers of the item to maximize potential sales (for which the content provider may receive a commission). Item 2 may be identified as being for sale by a particular retailer with whom content provider has a specified deal. Content provider may therefore wish to only have the image/item identified with the specific retailer. Based on agreements and decisions made by content providers, retailers and the intermediary, items for sale can be correspondingly associated with any and all retailers that appropriately offer the item.

FIG. 4 shows an exemplary listing for populating a registry (step 309 above). In this example, once content has been created, the process may register one or more aspects of the content with a retailer database. For example, the retailer may have an agreement whereby some portion of product sales are provided back to a consumer. Further, in either a billboard or interactive display on-site, the retailer may wish to display one or more aspects of the content relating to the original article, so that a consumer can more easily recognize the product.

For example, without limitation, if Magazine A ran an online article with a photograph of a man wearing a shirt, the shirt may be linked as purchasable content. Information about the article (a first paragraph, an associated paragraph, a title, etc) may be saved 403, along with any information about the content creator 401.

Also, the picture associated with the article may be saved 405, and, in the case of an interactive display, a hyperlink to the article may also be associated with the content 405. It may also be useful to save product information relating to the content, such as, but not limited to, SKUs, manufacturer, and other relevant information (color, etc.) 407. Finally, in this example, the process may save purchase point information 409, relating to one or more retailers where the product can be purchased, and which can be used to cross-reference the saved data to billboards, in-store displays, etc. of a particular retailer.

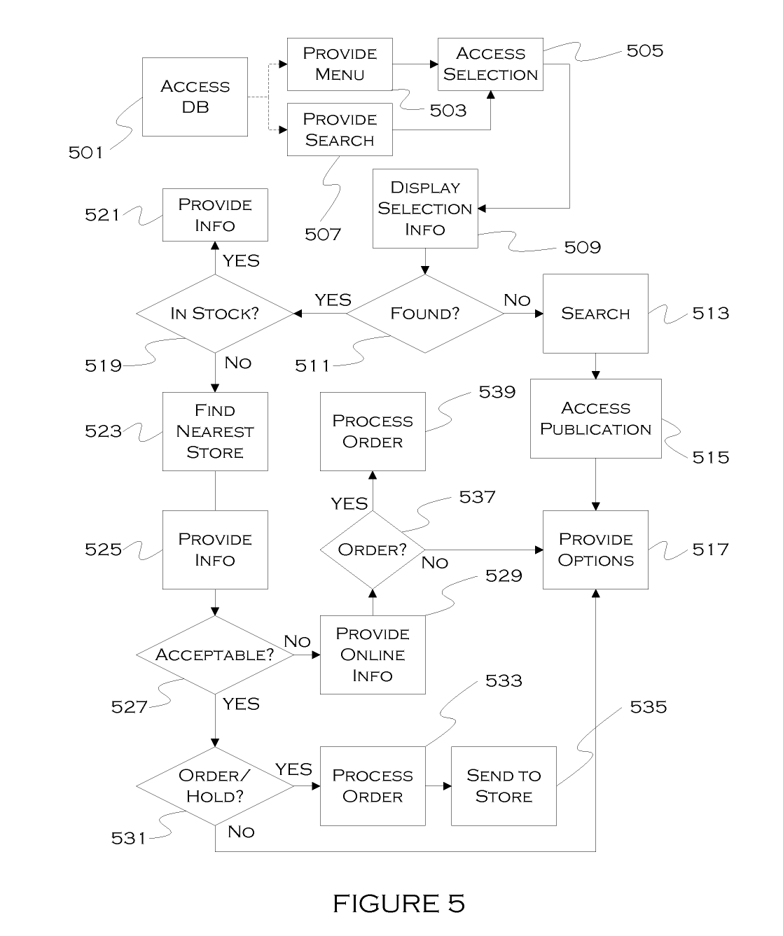

FIG. 5 shows an exemplary process for accessing an in-store, interactive display. In this illustrative example, content created in online publications containing products linked for sale can be accessed in the stores of retailers selling those products. Access can be obtained through in-store displays, tablet PCs, smart-phones, etc. Although this example deals with interactive content provision, it is also possible to provide dynamic non-interactive content based on the concepts herein. For example, without limitation, a display in a store or even a digital billboard could be dynamically updated with new content almost as soon as the content was created.

In the example shown in FIG. 5, a user is presented with an option to access a content database. This could be useful, for example, if the user had recently seen an article in an online publication, but didn't remember the exact product name linked with the article. By allowing the user to look up the article, or something associated with the article (such as, for example, Magazine A, Feb. 29, 2012), any linked products associated with the article, also sold by the retailer, may then be presented.

Such a search could be through a search screen 507 or, for example, a menu-driven screen 503, which may include the most popular publications, for example. Once the proper article/item is found, the customer can select access to the article/item 505 to find out more about the product 509 (e.g., price, location in store, in-stock, etc.).

If the product is found (i.e., if it is actually sold by the store) 511, the process can then check to see if the product is in stock 519. If the product is also in stock, price, location in store, and other details about the product can be displayed 521. If the product is not in stock, but is sold by that retailer, a nearest-store selling the product can be looked up 523, and information about that store and/or the product can be provided 525.

In this example, if the nearest store is acceptably close 527, the user can elect to have the item ordered and held on the spot 531. An actual order can be processed, or a temporary item-hold request could be placed 533. This request/order could then be sent to the appropriate store for handling.

If the store is too far away, the process can offer the user an option to order the item from online inventory 529. Such an option may be more secure if processed on, for example, a tablet PC or smart phone, but could also be done with a kiosk equipped with, for example, a credit card swiper. The order, if desired 537, could be processed 539 by the display device (tablet PC, smart phone, laptop, in-store display, etc.).

If the order is not desired, and/or, for example, if the user doesn't wish to travel to the other store or hold the item in waiting, the process may show in-stock in-store items that are similar (manufacturer, look, color, body part coverage, etc.) 517. This may help the customer select a suitable in-store alternative.

If the item from the article is not found as being for sale by the store 511, the process may search 513 for similar in-stock in-store items and/or other items for sale in that publication that the store does offer for sale 515. Any and/or all of these options may then be presented to the user as alternatives 517.

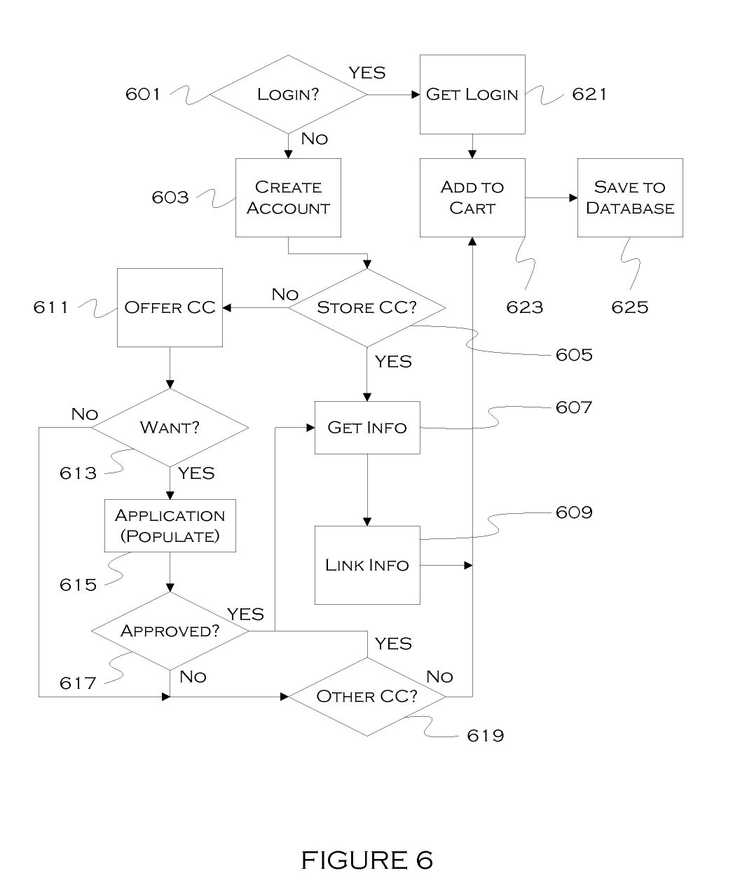

FIG. 6 shows an illustrative example of a process for providing a user with a “cart” containing selections of items seen in various online publications. Through use of a widget and/or, for example, a smartphone/tablet application, a user can select viewed content to be added to a personal cart. That cart can then be accessed in store, and the user can easily pull up a shopping list of items to purchase.

In this example, the user attempts to login to a cart. The cart can be associated with a user, a store or both. For example, if Scott shops at Store A and Store B, Scott may have a personal cart associated with his own shopping account. Items selected by Scott may be placed into the cart (essentially as reminders for a later list, e.g., a wish list, although they could also be made purchasable through the cart), and they could also be categorized within the cart by retailer. When Scott goes to Store A and uses an in-store display or network to access his cart, only the items for sale by that store could be displayed, for example (although complete display of items is also possible).

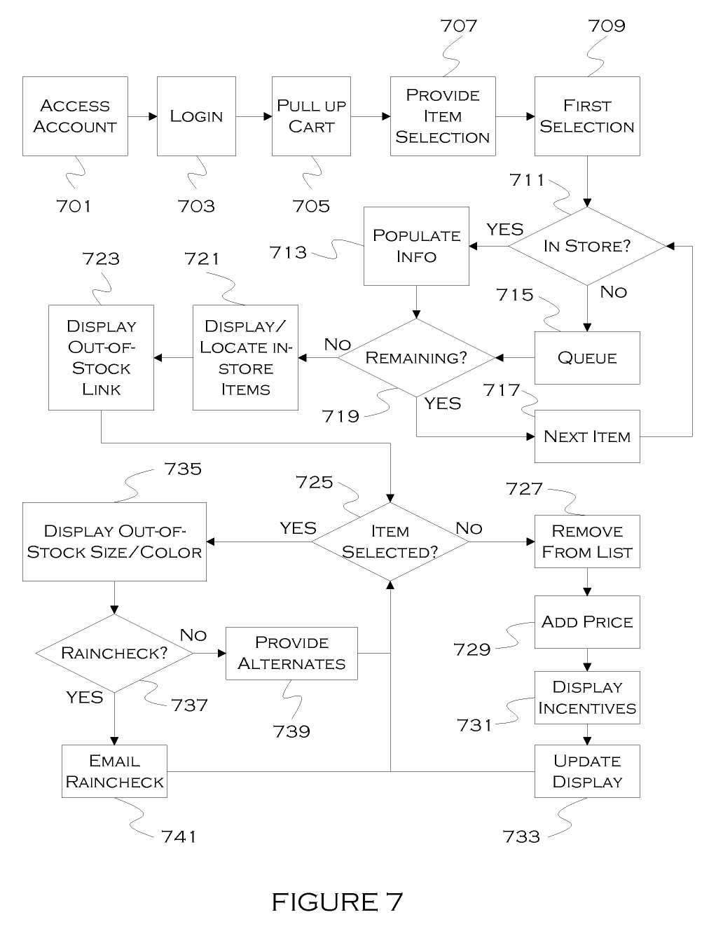

At the same time, Scott could elect to upload his cart to a store inventory system, and receive immediate feedback on which of his cart items were in-stock and in-store available at that moment. This will be described with greater detail with respect to FIG. 7.

In this process, the items are added to the cart 623 following log-in 621, and the cart is saved to a cloud-accessible database 625, for example, so that it can be later accessed in store. The cart could also be locally saved in a personal user database on a tablet or smartphone, for example.

If the user does not have an account, the process may offer the option to create an account. If the article selected for cart addition was sold by a particular retailer, the account may provide an option to link a store credit card 605 to the account (for easy purchase in-store, for example). If the user does not have a store credit card, the process may offer a store credit card 611, and if the user wants to apply 613, may populate the user's information 615 from user account information. If approved 617, the process may link the store credit card with the account information 609, along with user information such as preferred address for shipping, billing address, etc. 607.

If the user is not approved or does not want a store credit card, the process can provide the user with an option to link a different credit card 619, and, if accepted, store the similar information with the account.

It may be useful to have user credit card information stored because in-store displays accessible by a user can be viewed by passers by. If a user wishes to use an in-store display to pull up a saved cart, it may not bother the user too much if people see what the user is interested in purchasing. But, for example, if an item is out-of-stock, and the user wishes to order the item online, the user may not wish to enter credit card information into a public display in full view of everyone. This could be avoided by providing a credit card swiper, NFC enabled reader, or in this instance, by having credit card information already linked to the account.

By utilizing shipping only to pre-linked addresses, for example, the user could use both the saved credit card and shipping information to quickly order the item in-store without exposing private information to the public passing by. Dynamic address entry for shipping is possible as well, but pre-entered shipping addresses may help avoid misuse of a system by someone who improperly obtained cart login information.

FIG. 7 shows an illustrative example of a process for in-store cart item searching and recall. In this example, an application (running on, for example, a tablet or in-store display), can access a user account with a cart provider 701 and accept user login credentials 703.

The application can then retrieve a previously saved user cart 705 and provide a list of items saved by the user 707. In this example, the user may have saved more items than are desired to be purchased at that time, so the user is given the option to select individual items for purchase (or, for example, select all items). The process then checks a first user item 709 to see if it is in-stock in-store 711. If the item is available, information relating to the item is populated for future display 713 and the process moves to a next item 717, assuming one or more items remain 719.

If the item is out of stock or otherwise unavailable, the process may queue the item 715 for later handing and move to a next item 717. Once all items have been addressed (in this example all items are handled before display of info, but the process could also handle the items in groupings or individually), the process displays information relating to the particular items in-store and/or in-stock 721. Links for information on out-of-stock, online only, and unavailable items may also be provided 723. Handling of these items can be addressed as discussed with respect to FIG. 5, for example.

For the in-stock items, the process may allow a user to select a particular item once the user has picked up that item for purchase 725. For example, if a list included jeans, shirt and tie, once the user had picked up a tie, the item could be ticked off on the list. The item could then be removed from the list 727, and display of, for example, a price 729 and any incentives relating to purchase of, for example, multiple items or certain dollar amounts could be displayed (to encourage purchase of more items) 731. The process could then update the display. In this example, since the user is moving around and shopping utilizing the recalled cart, it may be more appropriate for use on a tablet or smart phone. If the in-store, mounted display was used, the process may cease at an appropriate point (such as, but not limited to, showing a user which items were in stock).

If a user then attempts to purchase the shirt, but the shirt is not available in a proper size, color, the user could utilize a link 735 to indicate the lack of the item. The user could be given a raincheck option 737, which could be emailed to a user (in the case of a sale on that shirt, for example) 741 and/or the user could be provided with suitable alternatives 739 (other similar items, other stores that have the item, online ordering of the item, etc.). This process can continue until all items on the user's shopping list have been addressed.

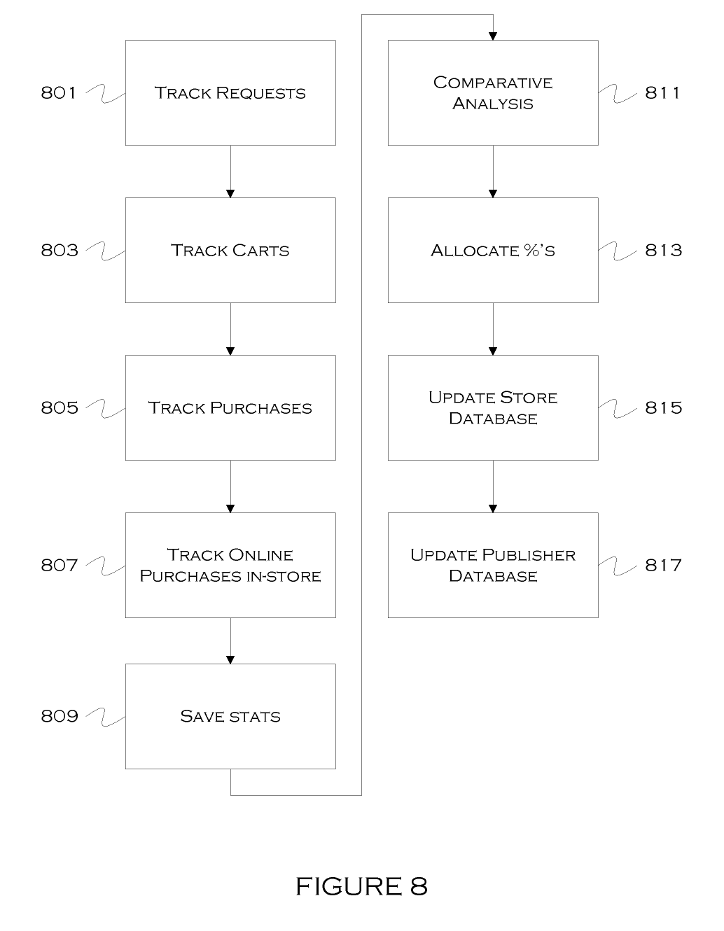

FIG. 8 shows an illustrative example of a process for providing data-feedback and/or a revenue source to online content creators. In this example, an in-store network can track all requests for particular articles/publications made on in-store displays or thorough tablets linked to an in-store network, for example 801.

The store can similarly track pre-saved shopping carts logged into by a user 803. The store can further track purchases of all goods and/or online purchases made while the user was physically present in the store 807 (e.g., out of stock in store purchases). These statistics can all be saved 809, and a comparative analysis can be performed against daily statistics from other days, to determine the “value” of a particular advertiser/content creator's content and how much should be allocated in fees.

Because the store may wish to incentivize content creators to create purchasable content that drives in-store visits, the stores may desire to provide monetary incentives to do so. This can be done by allocating some % of relevant sales 813 to each content provider whose content was accessed at least one time that day by customers in-store, updating both a store 815 and publisher 817 database with the information, so both parties can track the trail of the money.

For example, if Magazine A and Newspaper B both run online articles with a picture showing Shirt X, on day 1 there may be 50 accesses of the magazine A article in store and 20 accesses of the Newspaper B article. It may be observed that, on this day, 20 of the shirts were sold. On day 2, there may be 10 accesses of the Magazine A article and 60 accesses of the Newspaper B article, but only 7 shirts were sold. Initially, this would tend to indicate that Magazine A was driving a good deal more sales than Newspaper B (perhaps due to reader traits), and thus a greater percentage of sales should be attributed to Magazine A. Over time, such a comparative analysis can aid in developing models for various content providers that show their relative selling-power vs. other content providers.

At the same time, other metrics could be developed based on this modeling, such as the selling power of a particular person wearing an article of clothing, the selling power of differing colors of articles of clothing, etc. Also, it is important to note that, while a good deal of references to clothing have been made in this application, they are for exemplary purposes only, and are in no-way intended to limit the scope of the patent. Any saleable item could be covered by the implementations and embodiments disclosed hereby (and other, similar embodiments).

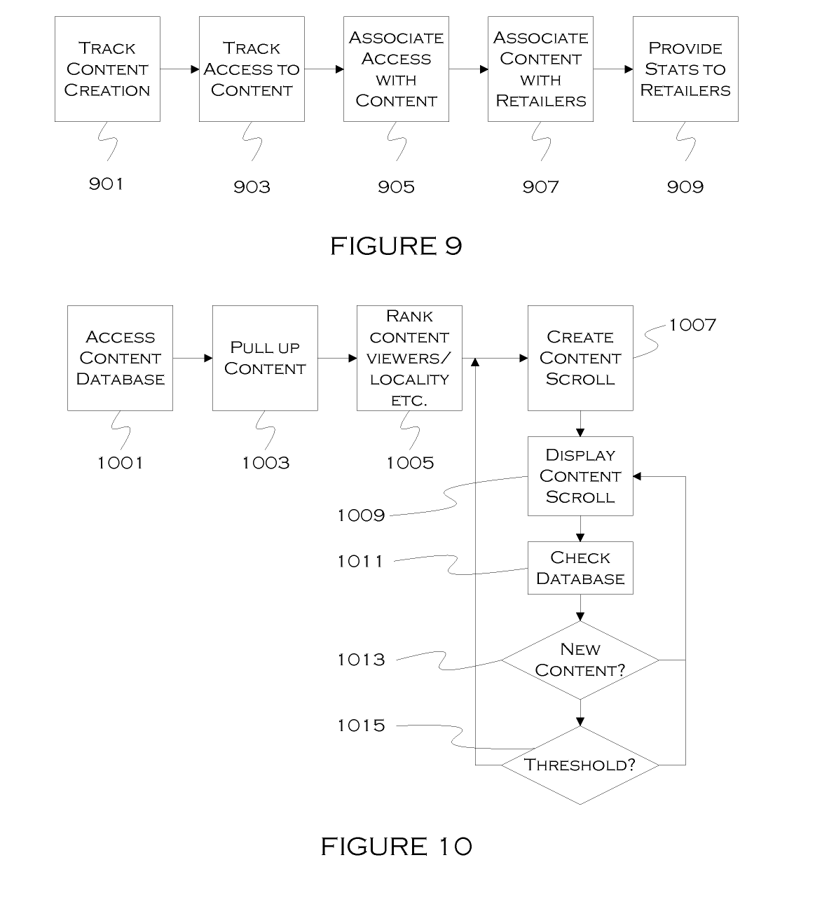

FIG. 9 shows an illustrative example of a process for determining which advertisements to be displayed on, for example, a digital display or billboard. Although a portion of this application has dealt with interactive displays, the processes can also be used to provide dynamically updateable non-interactive displays, such as, but not limited to, in-store display screens, digital road-side billboards, etc.

Since there could literally be thousands of content creation events per day, as thousands of blogs, publications and individuals create links to purchasable items displayed with online content, it may be useful to determine which items are most likely desirable for display.

The illustrative process shown in FIG. 9 shows that online content creation is tracked 901 so that a database can keep a record of some or all content created. Then, in this example, access to the content is also tracked 903. For example, magazine A, newspaper B and blog C may all create some new content for different purchasable items. Magazine A may have 100,000 readers, newspaper B may have 400,000 readers, and blog C may have 2,000 readers. Assuming these readers all view the content, the process could record 100,000 views of purchasable item A, 400,000 views of purchasable item B, and 2,000 views of purchasable item C. These views can then be associated with the particular items 905, and the items can be associated with the retailers who sell the items 907.

Statistics relating to the accesses of content can then be provided to retailers, for use in determining which items, and possibly for how long, should be displayed on an in-store display. For example, if an article featuring a famous person wearing sunglasses was run and received 2,000,000 views mid-day, a particular retailer of those sunglasses may dynamically adjust an in-store or roadside billboard to display the content from the article (picture, text, etc.) and possibly include something to the effect of “As featured in Magazine A”.

It may also be observed that, while Magazine A and blog C, in the example above, have fewer viewers than newspaper B, the viewers of magazine A and blog C may purchase associated items at a much higher rate. For example, if the author of blog C was a popular celebrity, and the blog was about things that were the celebrity's favorite, then viewers of that blog may purchase the items 95% of the time. Meanwhile, viewers of newspaper articles may only purchase the items 0.1% of the time, and so, after some period where this behavior can be observed and recorded, the viewing statistics can be appropriately altered (i.e., the blog has 1900 “effective” views and the newspaper has 400 “effective” views). Other suitable modifications of analysis as to which content should be utilized can also be implemented.

FIG. 10 shows an illustrative example of a process for providing one or more dynamically adjustable advertisements to consumers (through, for example, an in-store display, billboard, etc). In this example, the process will access a content database 1001 and pull up possible content to be displayed 1003 (e.g., in one instance, created content corresponding to items for sale in a particular store in which a display is mounted). The content can then be ranked based on some form of statistical analysis 1005 and one or more advertisements/displays can be added to a content scroll 1007.

It is also possible, for example, to rank some content higher based on localities of publishers (e.g., a local newspaper may be viewed as more valuable of a content creator in a locality covered by its physical distribution or location). In this illustrative example, the process will display the content scroll 1009 on a billboard or in-store display, and then can also periodically check a database 1011 for content updates 1013. If there is new content, it can be checked for viewership threshold statistics or other relevant thresholds 1015 to see if it qualifies for dynamic addition to a current content scroll (either replacing other content or taking a new place in line in a scroll). This allows retailers to take immediate advantage of new content creation and can help drive sales as fast as the purchasable content can be created.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive consumer identifying information provided to an in-store display;
receive a reference to online content;
retrieve information related to the online content, including one or more items for sale;
determine if at one or more of the items for sale are available in store; and
provide the user with information about the items, for any of one or more items for sale available in store.

2. The system of claim 1, wherein the online content is a digital magazine article, blog post, newspaper article or social networking entry.

3. The system of claim 1, wherein the online content is a content-to-commerce connection or advertisement.

4. The system of claim 1, wherein the information includes directions to where the user can find the item in the store.

5. The system of claim 1, wherein the information includes a price of the item.

6. The system of claim 1, wherein the processor is further configured to:
determine if any of the items for sale not available in store are available at another store location;
provide information about the other store location for any of the items for sale that are available at the other store location; and
provide a recommended similar item for at least one item for sale not available at any store location.

7. The system of claim 7, wherein the recommendation is provided for at least one item for sale not available at any store location within a predefined distance of a current store.

8. A computer-implemented method comprising:
receiving consumer identifying information provided to an in-store display;
receiving a reference to online content;
retrieving information related to the online content, including one or more items for sale;
determining if at one or more of the items for sale are available in store; and
providing the user with information about the items, for any of one or more items for sale available in store.

9. The method of claim 8, wherein the online content is a digital magazine article blog post, newspaper article or social networking entry.

10. The method of claim 8, wherein the online content is a content-to-commerce connection or advertisement.

11. The method of claim 8, wherein the information includes directions to where the user can find the item in the store.

12. The method of claim 8, wherein the information includes a price of the item.

13. The method of claim 8, wherein the processor is further configured to:
determine if any of the items for sale not available in store are available at another store location;
provide information about the other store location for any of the items for sale that are available at the other store location; and
provide a recommended similar item for at least one item for sale not available at any store location.

14. The method of claim 13, wherein the recommendation is provided for at least one item for sale not available at any store location within a predefined distance of a current store.

15. A non-transitory computer readable storage medium, storing instructions that, when executed by a processor, cause the processor to perform a method comprising:
receiving consumer identifying information provided to an in-store display;
receiving a reference to online content;
retrieving information related to the online content, including one or more items for sale;
determining if at one or more of the items for sale are available in store; and
providing the user with information about the items, for any of one or more items for sale available in store.

16. The storage medium of claim 15, wherein the online content is a digital magazine article, blog post, newspaper article or social networking entry . . . .

17. The storage medium of claim 15, wherein the online content is a content-to-commerce connection or advertisement.

18. The storage medium of claim 15, wherein the information includes directions to where the user can find the item in the store.

19. The storage medium of claim 15, wherein the information includes a price of the item.

20. The storage medium of claim 15, wherein the processor is further configured to:
determine if any of the items for sale not available in store are available at another store location;
provide information about the other store location for any of the items for sale that are available at the other store location; and
provide a recommended similar item for at least one item for sale not available at any store location.
